(19) United States
(12) Patent Application Publication
(10) Pub. No.: US 2025/0299397 A1
(43) Pub. Date: Sep. 25, 2025

(54) SIMULATION OF ANALOG FILM CHARACTERISTICS

(71) Applicant: INVIZIPRO LLC, Sacramento, CA (US)

(72) Inventor: Brendan BELLOMO, Agoura Hills, CA (US)

(21) Appl. No.: 18/859,957

(22) PCT Filed: Apr. 24, 2023
(86) PCT No.: PCT/US2023/019669

§ 371 Date: Oct. 24, 2024

Related U.S. Application Data
(60) Provisional application No. 63/334,662, filed on Apr. 25, 2022.

(51) Int. Cl. G06T 11/60; G06T 3/403; G06T 7/13

(52) U.S. Cl. CPC G06T 11/60; G06T 3/403; G06T 7/13; G06T 2207/10016; G06T 2207/20092; G06T 2207/20221; G06T 2207/20224

(57) ABSTRACT

A method performed by a processing device includes obtaining a first image of a sequence of images, obtaining a grain image having a plurality of grains, generating a resampled version of the first image including mapping pixels of the first image to different pixels in the second image based at least on a size of the plurality of grains in the grain film to generate the resampled version, and applying the grain image and the resampled version to the first image, resulting in a modified first image with the plurality of grains. Other aspects are described.

### CROSS-REFERENCE TO RELATED APPLICATIONS

This application is a U.S. National Stage of International Application No. PCT/US2023/019669 filed on Apr. 24, 2023 which claims priority to U.S. Provisional Patent Application No. 63/334,662 filed on Apr. 25, 2022, which are incorporated by reference herein in their entirety.

### TECHNICAL FIELD

Aspects of the present disclosure relate to image processing, and more particularly, to image processing to digitally simulate analog film characteristics.

### BACKGROUND

Analog film includes characteristics that are desirable for aesthetic and technical benefits. Yet, producing new content with analog film has significant logistical and technical drawbacks, such as being labor intensive and error prone. Analog celluloid film has a desirable, beautiful, cinematic look to its painterly color, color contrast, spatial contrast, dynamic range, apparent dynamic range, texture, inherent random grain movement, and resulting random image feature sampling. Analog film may also improve the ability for the human eye to view still movie scenes due to the inherent small-scale movement which gives an otherwise still scene a sense of liveliness, especially in comparison with digital cinematography.

### BRIEF DESCRIPTION OF THE SEVERAL VIEWS OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows a block diagram of an example computing device that may digitally simulate one or more characteristics of analog film, in accordance with some embodiments.

FIG. 2 illustrates an example process for simulating grain characteristics of analog film, in accordance with some embodiments.

FIG. 3 illustrates an example workflow for simulating grain characteristics of analog film, in accordance with some embodiments.

FIG. 4 shows an example of combining a grain image with a spatial map to resample an image, in accordance with some embodiments.

FIG. 5 illustrates an example image with light and dark regions that can be given analog film characteristics, in accordance with some embodiments.

FIG. 6 shows an example process for digitally simulating acutance of analog film, in accordance with some embodiments.

FIG. 7 illustrates an example flow diagram for digitally simulating acutance of analog film, in accordance with some embodiments.

FIG. 8 is a block diagram of an example computing device that may perform one or more of the operations described herein, in accordance with some embodiments.

FIG. 9 shows an example of resampling an image with distortion, in accordance with an embodiment.

### DETAILED DESCRIPTION

As described, analog film may have one or more aesthetic characteristics that provide visual benefits to the user. In addition to aesthetically pleasing attributes, some characteristics of analog film development may also improve human viewability of film. Background ‘movement’ of artifacts (e.g., grain) may be provided to relax eye muscle and improve eye concentration, for example, during still scenes.

Analog film typically includes visible grains that move or ‘dance’ over time. The grain is different from frame-to-frame, and it produces varied movement of small image features due to its random spatial variation. This gives motion pictures recorded on analog film a pleasing, small-scale movement to them, making analog film desirable to filmmakers for several reasons: the random movement is attractive to the audience's eye by making images come alive, it reduces skin tone blemishes, it adds pseudo realism to visual effects elements, it brings an authenticity to new stories by giving them an analogous aesthetic to favorite classic films, and it covers up missing details in art direction elements such as sets and costumes. In addition to the grain, analog film has a signature high contrast look that helps create eye-catching and dimensional imagery. This visually signals that certain white values are brighter than others, thus creating a more effective rendition of scenes with dynamic range beyond the recording medium's ability to capture that dynamic range. Film records color in a more painterly way than video: it compresses large scene exposure latitude (dynamic range of darkest elements to brightest elements in an image) into the smaller dynamic range of presentation media (i.e., the darkest black vs. the brightest white of a video display or projector). Different film stocks, filtration, and laboratory chemical processing can create distinct looks that alter color, contrast, hue, and saturation.

Current systems associated with digitally mimicking analog film lack flexibility in how effects are modulated, implemented, and presented with realistic effect. Such systems merely overlay grain on top of digital video images without accounting for additional attributes to present the overlaid grain in a manner that more accurately emulates effects of analog film. Some systems may use luminance mapping which may clip or have no grains in highs or lows. Such overlays inherently lack any random movement to the image features themselves. There is a need for improved methods and systems for simulating analog film grain with digital film, which may address shortcomings and limitations of current systems.

Aspects of the disclosure address the above-noted issues and other deficiencies. Aspects described perform video processing operations using analysis of visual attributes of analog film stock as well as analysis of traditional laboratory processing of analog film to more closely simulate these visual attributes in digital video. When such operations are applied to digital video footage, the resulting digital moving pictures may become indistinguishable from analog film moving pictures.

According to an embodiment, processes described emulate the path of light through the layers of film and into the developer chemical bath. These processes may characterize each stage of analog film development, the effect on the light, and the light's effect on the final film latent image. Since light travels through a series of materials in film media which influence each other and the next material, aspects of the present disclosure may simulate this serially through parallel processes and feedback between layers which may also be measured and simulated.

Using processes described, various advantages may be realized. For example, different effects may be contained within separate processes, thereby presenting filmmakers with the ability to apply some analog attributes and omit others (i.e., apply acutance but not grain). The described processes can simulate and preserve old or discontinued film stocks. In some embodiments, processes described may match video camera to film cameras allowing filmmakers to shoot with both formats. Further, digital footage may be digitally enlarged (zoomed in) with minimal loss in apparent quality since the grain and disclosed scattering effect increases apparent sharpness, thereby allowing a more visually forgiving enlargement since film grains remain at the correct scale (i.e., fine/small) and are not enlarged with the image itself. In addition, settings may be changed in post-production, whereas shooting analog film forces filmmakers to commit to aesthetic choices before shooting. In addition, attributes of different film stocks may be combined in various ways to create a ‘new’ analog film look. Thus, various benefits are realized with the processes described.

In some embodiments, a process may model the scattering and movement of film grains and the resulting random spatial sampling of the image, which produces a recorded image with moving features that resemble the same movement in analog film. The process may model the adaptive amount of apparent image feature scattering/movement based on edge detection. High contrast edges may be given less scatter than low contrast edges. The process may model tonal grain response that resembles the granularity of film at different exposures based on a more realistic approach than using a typical luminance key. Additionally, or alternatively, a process may model the signature contrast of analog film, which may be referred to as acutance.

In one aspect, a system or method performed by a processing device, may include obtaining a first image of a sequence of images; obtaining a grain image having a plurality of grains; generating a resampled version of the first image including mapping pixels of the first image to different pixels in the second image based at least on a size of the plurality of grains in the film grain to generate the resampled version of the first image; and applying the grain image and the resampled version to the first image, resulting in a modified first image with the plurality of grains. The resulting modified first image may have a grain effect with a corresponding distortion (e.g., scatter) that more closely resembles the grain effect that is naturally present in analog film.

In one aspect, a system or method performed by a processing device includes obtaining a first image of a sequence of images, generating a blurred version of the first image, determining a difference between the first image and the blurred version, in response to the difference between the blurred version and the first image being positive, screening the difference over the first image resulting in a screened first image, and blending the screened first image with the first image. The resulting modified first image may have effect of acutance that resembles sharpness characteristics naturally present in analog film.

Aspects and embodiments of the disclosure may be combined to provide enhanced emulation of analog film. For example, the modified first image with the grain effect may be combined or blended with the modified first image with the acutance. Other aspects and embodiments may be combined or performed together in parallel or serially.

Some or all the described operations may be performed automatically (e.g., without human input) by processing logic. Processing logic may comprise hardware (e.g., circuitry, dedicated logic, programmable logic, a processor, a processing device, a central processing unit (CPU), a graphics processing unit (GPU), a system-on-chip (SoC), etc.), software (e.g., instructions running/executing on a processing device), firmware (e.g., microcode), or a combination thereof.

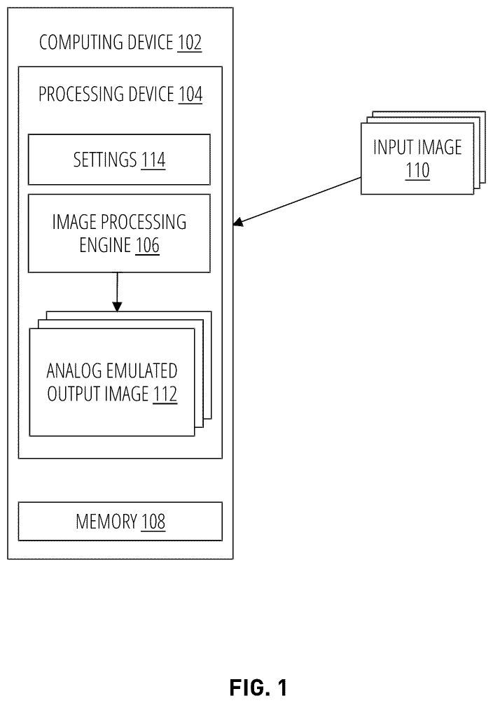

FIG. 1 shows a block diagram of an example computing device that may digitally model one or more attributes of analog film, in accordance with some embodiments. Computing device 102 includes a processing device 104 and a memory 108. Memory 108 may include volatile memory devices (e.g., random access memory (RAM)), non-volatile memory devices (e.g., flash memory) and/or other types of memory devices. Computing device 102 may include processing logic such as processing device 104.

Computing device 102 may be a single computer or it may represent multiple computers which may be communicatively coupled over a computer network (not shown). Processing device 104 may include an image processing engine 106. The image processing engine 106 may comprise one or more computer programs including executable instructions stored in computer-readable memory (e.g., memory 108) to perform processes described.

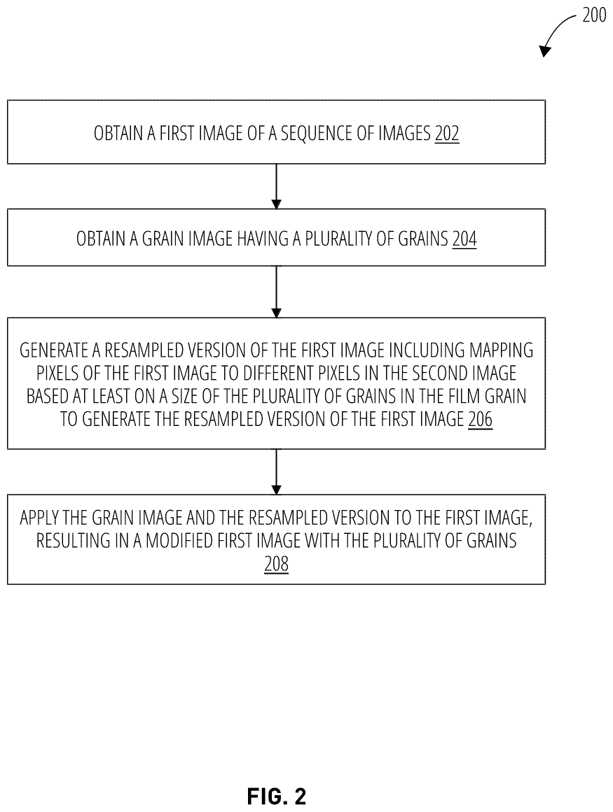

In one aspect, image processing engine 106 may obtain one or more input images 110. This input image 110 may be one of a sequence of digital images that together form a digital video (motion picture). Image processing engine 106 may perform image processing operations such as those described with respect to any of FIG. 2 to FIG. 7 to produce one or more analog emulated output images 112. The analog emulated output image 112 may include a grain effect (with scattering), or acutance, or both.

For example, in one aspect, image processing engine 106 may obtain a grain image having a plurality of grains. The image processing engine 106 may generate a resampled version of the first image including mapping pixels of the first image to different pixels in the second image based at least on a size of the plurality of grains in the film grain to generate the resampled version of the first image. The image processing engine 106 may apply the grain image and the resampled version to the first image, resulting in a modified first image (e.g., 112) with the plurality of grains. The resulting modified first image may have a grain effect with a corresponding scattering that more closely resembles the grain that is naturally present in analog film.

Additionally, or alternatively, image processing engine 106 may generate a blurred version of the first image. Image processing engine may determine a difference between the first image and the blurred version. In response to the difference between the blurred version and the first image being positive, image processing engine 106 may screen the difference over the first image resulting in a screened first image, and blending the screened first image with the first image. In response to the difference being negative, the processing engine 106 may perform additional operations (e.g., negate or invert) to still blend the screened first image with the first image, as described in other sections. Regardless, the resulting modified first image may have effect of acutance that resembles characteristics naturally present in analog film.

In an optional embodiment, all user definable settings and/or default settings may be stored in settings 114 which are adjustable within the interface of the present invention. The settings can be saved to memory 108. For example, settings 114 may be saved in a plain text preset file, which names each parameter and its stored value. In an embodiment, the processing device 104 can also load these preset files, parse them and apply the stored settings. In an embodiment, this allows the settings to be adjusted to faithfully emulate all aspects of a film stock, including the settings for grain image selection, grain intensity, shadow grains, scatter, acutance, or other described features. The settings 114 may be stored in memory 108, adjusted, and later recalled for use or editing.

In an embodiment, image processing engine 106 may be programmed and packaged in the OpenFX (OFX) Image Effect Plug-in API, which is an open standard for 2D visual effects or compositing plug-ins. This allows the image processing engine 106 to be operated within a variety of host software, such as, for example, Blackmagic DaVinci Resolve, Foundry Nuke, and FilmLight Baselight.

Because video input is a series of frames (distinct individual images), individual frames can be processed in parallel streams. As such, in an embodiment, the processing device 104 includes multiple graphics processing units (GPUs) where each GPU may perform operations of image processing engine 106 independently with identical settings, allowing for near linear processing speed grains with additional GPUs added. Each GPU may independently process a different image from an image sequence in parallel, to carry out faster operation. All processes may be performed in linear color space with 32 bit float color precision. In an embodiment, the image processing engine 106 includes a host application that receives the processed video frames from the GPU(s) and recombines and displays them for viewing, or renders them to memory 108 (e.g., a disk), or both. In an embodiment, the image processing engine 106 may be compatible with Linux, Windows, Mac OS, or other equivalent operating system environment.

In an embodiment, input image 110 may be received as video input in linear RGB color space from a host application. Input image 110 may be received as a single frame of the video input.

FIG. 2 illustrates an example method for simulating grain characteristics of analog film, in accordance with some embodiments. The method may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

With reference to FIG. 2, method 200 illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in method 200 may be performed in an order different than presented, and that not all of the blocks in the method may be performed.

At block 202, processing logic may obtain a first image of a sequence of images. The sequence of images may be digital video file. At block 204, processing logic may obtain a grain image having a plurality of grains. The grain image may be generated based on scanned analog film. Additional processing may be performed on the scanned analog film to generate one or more stock grain images. Blocks 202 and 204 may be performed in parallel.

At block 206, processing logic may generate a resampled version of the first image including mapping pixels of the first image to different pixels in the second image based at least on a size of the plurality of grains in the grain film to generate the resampled version.

At block 208, processing logic may apply the grain image and the resampled version to the first image, resulting in a modified first image with the plurality of grains. This application may include overlaying the grain image on the resampled image with an opacity less than 100%. Other aspects are described that emphasize or de-emphasize the visibility of grain at different regions of the same image.

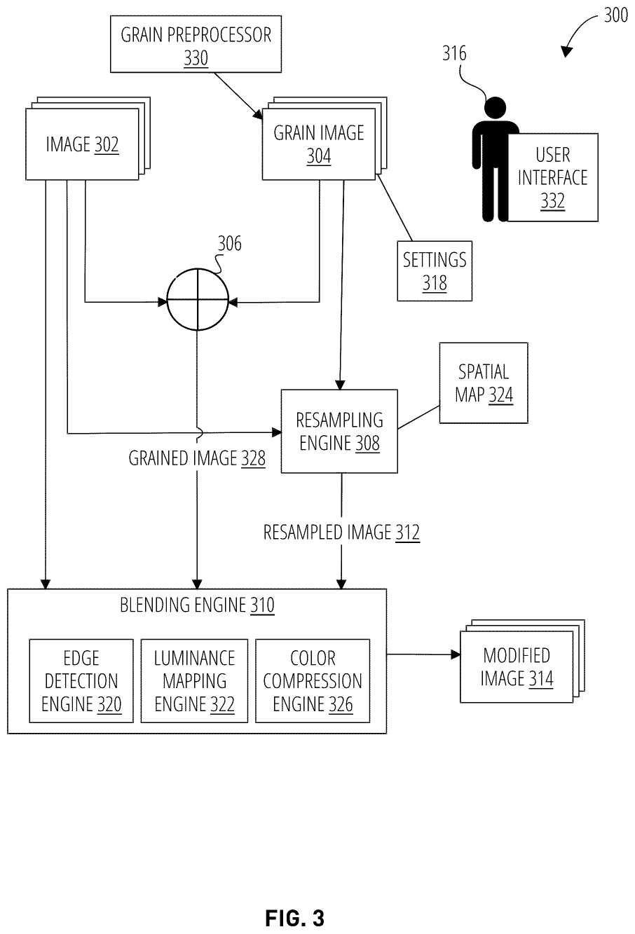

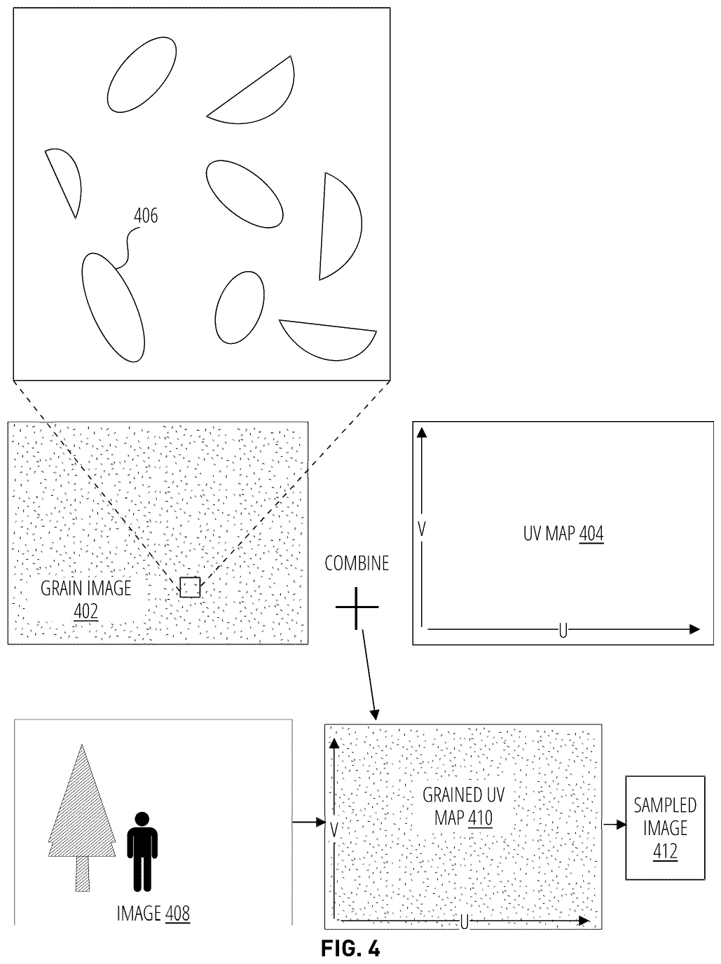

The method may be repeated for each image in the sequence of images. In an embodiment, the method is performed in parallel for multiple images in the sequence of images. In an embodiment, a subsequently processed image may use a different grain image than used for the previous image, so that the grain appears to move over time. Embodiments of method 200 are described further in other sections, such as with respect to FIG. 3 and FIG. 4.

FIG. 3 illustrates an example system 300 for simulating grain characteristics of analog film, in accordance with some embodiments. The system 300 may correspond to computing device 102. Each of the various engines and blocks described may be performed by processing logic of the system 300.

The system may obtain images 302. Images 302 may include a sequence of digital images of a motion picture captured digitally. Each image may be referred to as a frame. The format of images 302 may vary depending on application. For example, the number of frames per second may vary from one asset to another. Similarly, the size and quality of each image may vary depending on application. The images 302 may represent the digital asset that will processed to give an analog ‘grain’ effect. Various digital video formats exist with varying size, quality, etc.

One or more grain images 304 may be obtained and applied to one of images 302. In one embodiment, each of the one or more grain images are generated by scanning real analog film stock. The analog film stock may be shot on spectrally neutral background. For example, the film stock may be shot on an evenly illuminated gray background. Each grain image may include grains that are randomly dispersed throughout the image. The grains may provide the basis for the spatial scattering and grain texture/color that are applied to the images 302, as described.

In an embodiment, after analog film is developed, a negative or reversal (positive) analog film is scanned. For example, a DFT Scanity motion picture film scanner may be used to scan the film, resulting in 4K, 16 mm, or 6K 4-perforation 35 mm LOG 10-bit DPX files. Or a Pacific Image XAs 35 mm still film scanner can be used to produce 14K 136 megapixel 16-bit images from an 8-perforation 35 mm image (i.e., VistaVision).

The scanned grain may be pre-processed (e.g., by grain preprocessor 330) to prepare it for combining with digital images 302. In an embodiment, base color cast (i.e., the orange cast present in color negative film) is removed to produce a color neutral scanned image, the negative image is inverted to obtain a positive (normal) image, and color is calibrated based on the film brand and film stock.

In an embodiment, grain images are pre-processed to produce uniform, dust-free grain images. The process may be repeated with different initial dimensions of the grain images to generate grain images 304, each having a standard format such as, for example, 8 mm, 16 mm, Super16, 35 mm and Vista Vision (36 mm×24 mm). This provides that the density of grains precisely matches the density in each format.

The grain images 304 may be associated with different settings 318. For example, one set of grain images 304 may correspond to a first type of analog film (e.g., 35 mm film scan). Another set of grain images 304 may correspond to a different analog film (e.g., 16 mm film). The storage quality of the grains may depend on the corresponding analog film. For example, 35 mm film scans may be stored with a higher quality setting than 16 mm grains since there are more grains stored within a given 4096x4096 image in 35 mm than 16 mm. The higher grain count of some analog film may benefit from a higher quality setting to maintain the fidelity of the individual grains in the corresponding grain image 304. In one embodiment, a lossless PIZ Wavelet compression scheme may be used by system 300 to reduce file size of the grain images 304. This lossless format has no effect on image quality.

In real analog film, each frame has a unique grain pattern. In an embodiment, grain images 304 are generated with combined smaller grain images. This may vastly reduce hard drive space and graphics memory usage by using a smaller set of grain images to generate a larger number of grain images, rather than storing thousands of grain images.

At block 306, the system 300 obtains one of the images 302 and combines this image with one of the grain images 304. The grain image 304 may be overlaid on the image 302 with an opacity (e.g., less than 100% opacity, less than 50% opacity, or less than 25% opacity). In some embodiments, the opacity of the grain image over image 302 may be determined based on (e.g., in proportion to) a luma key. Luma keys provide a way to composite a foreground clip over a background clip based on the luma levels in the video. The luma key may be used to isolate elements of an image or a video by their brightness. For example, each region (e.g., a pixel or grouping of pixels) may have a luminance value. Depending on the luminance value, the opacity at that region may be increased or decreased.

In some examples, regions with a lower luminance value will be given an emphasized appearance of the foreground grains (e.g., with an increased opacity of the grain image at that region). Regions with higher luminance value may have less visible grains (e.g., with a decreased opacity of the grain image in those regions). The opacity levels of the grain layer over the image layer in a given region may be mapped to the luminance of that region, and then applied per region (e.g., per pixel or grouping of pixels) for each and every region of the resulting grained image 328.

Resampling engine 308 may generate a resampled version 312 of the first image. Resampling engine 308 may serve as a scatter filter to emulate how random grains produce random spatial sampling of color and luminance values. This may result in a movement of final detail local image structure from frame to frame akin to jiggling and may provide a distinct look that gives digital film footage additional life and movement that is typically seen in analog film. Since the grain size, texture, sharpness, distribution, and placement in each film stock and in each frame of each film stock is distinct and unique, the resampling engine 308 may use the grain image 304 to spatially re-construct each image 302. This may be done prior to or separate from applying overlays of grain images (e.g., at blending engine 310).

Resampling may refer to filling a region (e.g., a pixel) of a destination image with a color ‘sample’ taken from a sampled image. The resampling engine 308 may map pixels of the first image to different pixels in the second image (the resampled image 312) based at least on a size of the plurality of grains in the grain film to generate the resampled version. Resampling engine 308 may, for each position (e.g., pixel) in the resampled image 312, obtain a sample at the image 302 at a different position. This may be referred to as spatial sampling. The resampled image 312 is a resampled version of the original image 302. The position at which the sampling is taken from the image 302 may depend on the size of the grains in grain image 304. For example, to get the color for position X, Y, of the resampled image, resampling engine 308 may take the sample at position X+Offset1, Y+Offset2 of image 302. Offset1 and/or Offset2 may correspond to the size of the grain at position X, Y of the original image, such that as the grain size increases, the size of the offset also increases, and as the grain size decreases, the size of the offset decreases. This sampling process may be performed for each position in the resampled image 312 to generate resampled image 312 from the original image 302. Areas where one or more grains lay will have a distortion effect on the surrounding areas of the resampled image 312.

In some examples, resampling engine 308 may use a spatial map 324 as the mechanism to perform spatial resampling. The resampling engine 308 may combine the grain image 304 with a spatial map 324 to generate a modified spatial map that serves as a key to distort an image as a function of grain size, position, or both. The modified spatial map may be applied to the first image to map pixels of the first image to different pixels in the second image. This samples the image 302 at different coordinates and places the sampled color value into resampled image 312 at different locations, according to at least the size and a geometry of the plurality of grains. In some examples, the spatial map 324 is a UV map, as described in other sections.

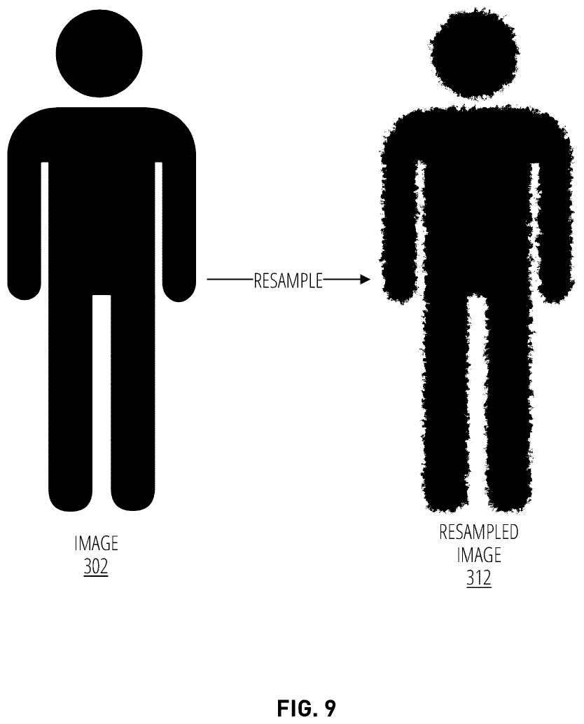

FIG. 9 shows a simplified example of resampling, according to an embodiment. Original image 302 is serves as a palette to generate resampled image 312 through the operations described in the present disclosure. Pixels are sampled from image 302 and used to ‘fill’ pixels in resampled image 312, but with some displacement. This mapping may be performed for each pixel in image 302 and resampled image 312. The displacement from the original image 302 to the resampled image 312 may correspond to the grain pattern, size, density, such that as the grain size increases, so does displacement of sampling. The underlying structure of image 302, however, is still visibly present in resampled image 312.

Referring back to FIG. 3, at blending engine 310, the system may apply the resampled version 312 to the image 302. In one embodiment, the blending engine 310 may include an edge detection engine 320 that determines one or more edges in the image 302 and blends the resampled version 312 with the image 302 with a reduced a visibility of the resampled version resampled image 312. As a result, the modified image 314 may show reduced visibility of the resampling at edges in the image.

In one embodiment, the blending engine 310 may increase or decrease a visibility of the resampled image 312 in different regions of the modified image 314 according to a brightness of the first image. For example, regions of modified image 314 with higher brightness may show less of resampled image 312, while regions of modified image 314 with lower brightness show more of resampled image 312. Blending engine 310 may include a luminance mapping engine 322 that determines luminance at each position, and emphasizes or de-emphasizes the visibility of the resampled image 312 at that position according to the luminance at that position. As described, this may be done with a luma key.

The resampled image 312 is then blended with image 302 at a certain mix less than 100% opacity. The edge detection engine 320 may apply an edge matte that further reduces this percentage factored in. Statistically, the multitude of grains and resultant analog over-sampling performed by system 300 produces a modified image 314 that is mostly spatially coherent with the incoming light from the lens (i.e., spatially undistorted/non-turbulent) but is somewhat turbulent/distorted by the grain pattern of grain image 304 with respect to the edge detection and luminance mapping.

In an embodiment, the system 300 may increase or decrease a visibility of the grain image 304 in different regions of the modified image 314 according to a brightness (e.g., luminance) of the first image. Although shown to be combined at block 306, the obtained grain image 304 may instead be applied direct to the image 302 at blending engine 310.

In an embodiment, settings 318 may give a user options as to the size or pattern of the grain image 304, how the system resamples an image 302, or how the system blends the sampled image and grains with the image 302. For example, some black and white stocks have less layering and thus high distortion mix. Color stocks may have larger grains, but their high grain count and many layers allow for over-sampling and less apparent distortion and thus often have a lower distortion mix.

Settings 318 may allow a user 316 to choose or save settings to control how the modified image 314 is generated. For example, user 316 may provide user input through a graphical user interface 332 to select one of settings 318. Each of the settings may be associated with at least one of the size of the plurality of grains, a density of the plurality of grains, color of a plurality of grains, or a geometry of the plurality of grains. For example, a setting for ‘16 mm’ may correspond to a first grain size, grain density, grain color, and/or grain geometry. A second setting for a different film stock (e.g., ‘35 mm’) may have a different grain size, grain density, grain color, and/or grain geometry, and so on. As such, the system 300 may provide the user with one or more settings 318 that are pre-loaded to present the user with a selection as to which analog film stock to emulate. Further, the system may allow the user to modify settings 318 to adjust grain size, resampling intensity based on edge detection, resampling intensity based on luminance, grain visibility based on luminance, and/or other settings.

In some aspects, grain preprocessor 330 may obtain raw grain images (e.g., from film stock) and generate one or more grain images 304. In an embodiment, in order to apply grain to a video clip, grain preprocessor 330 may determine the resolution of grain image 304 and generate grain image 304 with the same resolution as image 302. Given that various video clip resolutions may be used (e.g., 1280×720, 1920×1080, 2048×1152, 1920×800, 3840×2160, 4096×2160), rather than creating and storing every resolution of grain that an end user might require, grain preprocessor 330 may dynamically generate and scale grain images 304 to match the resolution of the image 302 of the video clip. This saves significant hard drive storage space.

In an embodiment, the grain preprocessor 330 may obtain digitized scanned analog film with a desired sharpness profile. For example, different film scanners produce sharper or softer film grain. The grain preprocessor 330 may model sharpness of actual film scanners.

In an embodiment, system 300 may adjust the gain of the grain image based on user input to adjust how visible the grain is in grained image 328. The blending engine 310, may apply the grain image 304 by overlaying it over an image 302. Luminance mapping engine 322 may generate a luminance key (which may also be referred to as a luma key) of the input image 302. This luminance key may be generated based on an S-curve with default or user parameters that define the shape of the S-curve. The shape of this curve can be modified (e.g., based on user input or automatically) to apply the appropriate amount of grain in the low mid-tones, mid tones, and mid-highlights of the input when the grained image 328 is blended with the input image 302. In such a manner, the system may adjust the grain luminance response of the modified image 314 to emulate a specific film stock, for example, image areas of different brightness may be given different intensities of grain.

A standard overlay layer blending alone may not sufficiently emulate grain behavior relative to the black/dark or white/highlight sections of the input image, which is a problem with conventional grain-emulation methods. The system 300 may address this by applying pre-color correction to the image 302 before overlaying the grain with the luminance map. This pre-color correction may consist of a lift and a gain operation to tonally compress the video image, turning blacks to dark gray and whites to light gray, so there are no pure blacks or pure whites. Then the grain image 304 or grained image 328 is overlaid on the image 302 with the luminance key as its intensity matte. The blending engine 310 may take the resulting image and perform the reverse the lift and gain color corrections to return that image to the original color. The result is a tonal mapping of grain across the luminance range of the image with a signal-to-noise ratio that is more akin to analog film with respect to the black/dark and white/highlight sections.

For example, color compression engine 326 may compress a color range of the image 302 to a reduced color range. The color range may be compressed in proportion to a desired granularity, turning the darkest blacks and the whitest whites grayer. The grained image 328 is blended and the resampled image 312 may be blended with the image 302 with the reduced color range. The color compression engine 326 may expand the reduced color range of the resulting blended first image, which is formed from combining the image 302 with grained image 328 and resampled image 312, back to its initial color range, to generate the modified image 314.

Analog film stocks may use a mix of larger and smaller grains. The larger grains are more sensitive to photons and thus are added to make film stocks more sensitive in darker shooting conditions where less light is available to create an exposure. These larger grains, however, appear visually larger in the final image and furthermore are more visible in the darker, shadow areas of the image, where a single exposed grain that would become bright would be surrounded primarily by much darker image content, and thus would stand out. In an embodiment, the system 300 can simulate these ‘shadow grains’ separately by applying a second scatter filter process to the same image 302, utilizing an enlarged grain element as the UV source and grain overlay source.

For example, system 300 may, for the same image 302, also select a second grain image with larger grain, and repeat the step of resampling with the larger grains. Blending engine 310 may take this additional resampled image (not shown) and blend this additional resampled image into the shadow areas of the video input. For example, luminance mapping engine 322 may use a luminance key to target only the darker image areas (with a falloff at a luminance threshold). The additional resampled image (with the larger grain) may not be applied to the lighter areas of the image 302. In an embodiment, the enlarged shadow grain element scale, shadow grain overlay intensity, shadow grain luminance key sensitivity and falloff may be stored in settings 318 which may include default shadow grain settings, user adjustable shadow grain settings, or both.

FIG. 4 shows an example of combining a grain image with a spatial map to resample an image, according to some embodiments. The example may correspond to operations described with respect to resampling engine 308 and spatial map 324. As described, the system (e.g., system 300 or processing logic thereof) may generate a resampled version of a first image 408 through mapping pixels of the first image to different pixels in a second image. This resampling may be based at least on a size of the grains in the grain film. Image 408 may correspond to an image 302 or 110 as described in other sections.

Grain image 402 may include a plurality of grains 406. Depending on the underlying analog film stock used to generate the grain, the pattern, size, texture, and density of the grain may vary. Further, the shape and/or size of each grain 406 may vary from one stock to another, or even within the same stock. The spacing or density of the grain within a grain image 402 may be uniform or substantially uniform throughout the image, to allow for predictable processing of the grain image to emulate changes due to edge detection or brightness, as described in other sections.

In an embodiment, a spatial map such as a UV map 404 may be used as the mechanism to map the sample locations from the first image 408 to the sampled image 412. The grain image 402 may be combined with the spatial map (e.g., UV map 404) to resample image 408 according to the position, size, and shape of each grain 406 in grain image 402. The amount of grain combined with the spatial map is directly proportional to how much spatial scattering will occur in the sampled image 412.

UV map 404 may be generated at the same resolution as the video image 408. The UV map 404 may have a unique red, green color value for every pixel location in the original video image. The red gradient changes from left to right. Similarly, the green gradient changes from down to up. As such, each pixel may have a U (red) and V (green) value that represents the absolute position of a pixel in source image 408. The UV values may be normalized between 0 and 1, where 0,0 is the bottom left corner of the input image, and 1,1 is the top right corner. To combine the grain image 402 with the UV map 404, processing logic may overlay the grain image 402 over the UV map 404 at a given user defined opacity, which distorts the underlying UV values, resulting in a grained UV map 410 where the regions of the UV map 404 that are directly underneath each individual grain 406 has the UV values distorted.

This grained UV map 410 may be used as a map to resample image 408, which effectively applies a shift to the original position values in image 408 in accordance with the pattern, size, geometry, texture, and density of the grain image 402. The grained UV map 410 may also be referred to as a scatter map. Similarly, resampling the image 408 may be referred to as a scattering process. This process may use the two channels of the grained UV map 410, U (red) and V (green), to figure out where each pixel in the resulting image 412 should come from in the channels of the input image 408. Those U (Red) and V (Green) values may serve as the absolute position of the source pixel in the input sample.

Through this process the size, density, and pattern of the grains is coupled with the distortion in the resulting sampled image 412. These spatial sampling offsets differ from frame to frame as the grain image 402 changes from frame to frame. The resulting sampled images strongly emulates the random sampling of light within an analog film emulsion, in which every analog image is constructed by the sum of colors of randomly distributed grains and in which the color of each grain and underlying local distortion are visually correlated.

The resulting sampled image 412 may have a pointillistic texture, however, repeated over a plurality of frames with different grain images. The result becomes a moving image with a dancing, wiggling motion in the fine details and edges of image features. This is a primary characteristic of the distinct textural movement captured in analog moving pictures. This gives analog film movement and other technical and aesthetic qualities. Furthermore, this may smooth out and create smooth skin tones by reducing visibility of blemishes and pores. Further, it improves visual engagement and stimulation, even when showing an otherwise static image like a landscape with little to no camera movement by emulating the moving texture of analog film on a video input. As such, this randomized yet spatially coupled grain and resampling may improve viewability and visibility of the underlying image 408, when combined with sampled image 412 (e.g., at blending engine 310).

Further, as described, a second grain image (not shown) may be obtained with greater grain size than grain image 402. The same process may be performed to determine a second sampled image 412 which may be applied at the darker regions of image 408 (e.g., satisfying a darkness threshold).

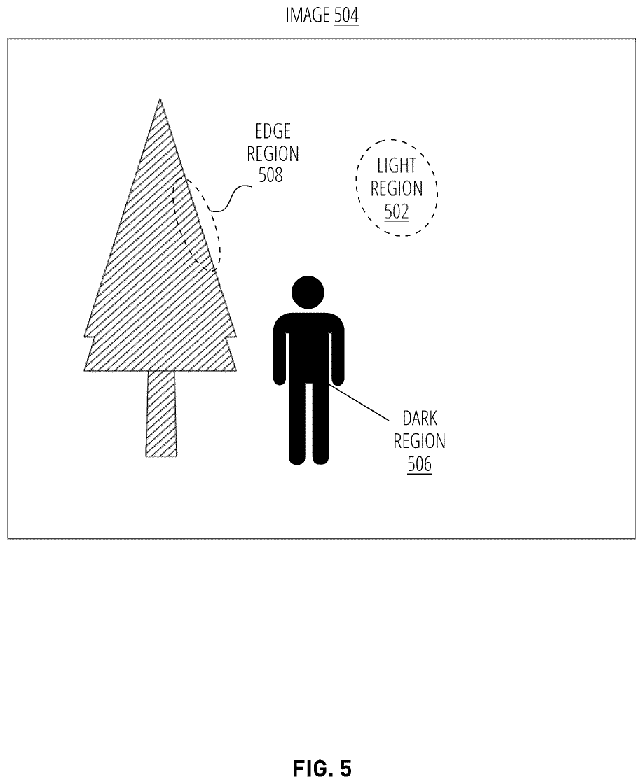

FIG. 5 illustrates an example image that can be given analog film characteristics, in accordance with some embodiments. Image 504 may represent a digital image taken from a sequence of digital images that form a motion picture. The image 504 is simplified to illustrate one or more described features, but it should be understood that image 504 may be a realistic image taken from a camera. The image 504 may include one or more objects and one or more light sources. Regions of the image 504 may have different luminance characteristics, depending on color, light, etc. For example, some regions may be bright, such as light region 502. Other regions may be dark such as dark region 506. Further, some regions may include an edge region 508 where a light region and dark region intersect.

In an embodiment, the system (e.g., system 300 or computing device 102) may use luminance mapping to emphasize grain visibility and/or distortion in darker regions and reducing the grain visibility and/or distortion in the lighter regions. For example, in a dark region 506 where less light is present, a grain image that is overlaid on image 504 may have greater opacity than in light region 502 where more light is present. Each region of image 504 may be measured for luminance and a corresponding gain or opacity may be applied to the overlaid grain layer to emphasize or de-emphasize the grain at that region accordingly. This may be performed at block 306 and/or blending engine 310. In an embodiment, dark region 506 may further include visibility of larger grains and sampling based on larger grains, such as ‘shadow grains’, as described in other sections.

In an embodiment, the system may reduce the described scattering effect at edges. A small percentage of the original video image may be blended back into the result of the scatter filter in some sections, such as where an edge is detected. An edge region 508 may have one or more statistically high contrast edges. These edge regions and more brightly exposed areas such as light region 502 are less distorted in analog film due to workings of analog film-many grains are exposed in these areas and not exposed in close proximity. Statistically, this high exposure of grains in these regions result in a reduced distortion (e.g., less wiggling).

In an embodiment, generating reducing scattering at one or more edge regions 508 of the output image (e.g., modified image 314) may include performing a Sobel edge detect filter on the image 504. This filter may be adjusted based on a sensitivity setting which may have a default value and/or be adjusted based on user input. The filter may produce one or more edge area alpha mattes on the image 504 that indicate edge regions such as 508. Wherever the edge region 508 is detected, the system may reduce the intensity of the resampling (e.g., by reducing how much the resampled image is blended in with the original image at that region). For example, the resampled image 312 may be blended back with the original video image 302 (e.g., at blending engine 310) at a reduced opacity or gain. A user may adjust how much the scattering is reduced at the one or more edge regions 508 based on a gain or falloff value.

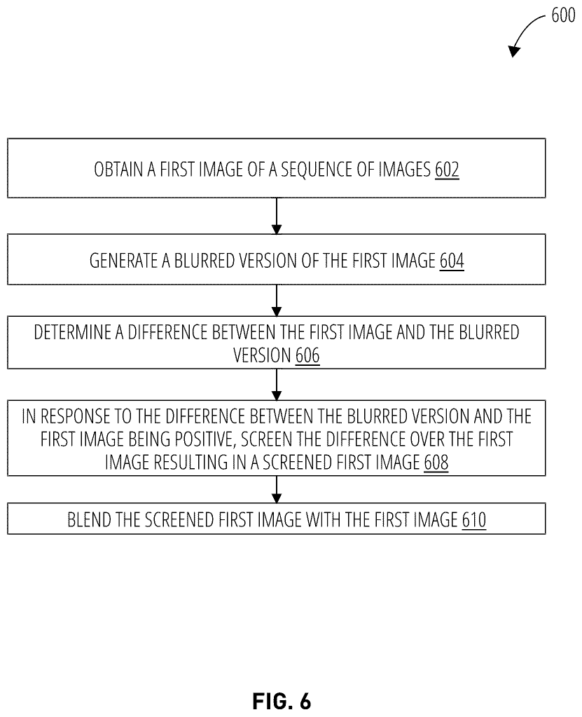

FIG. 6 shows an example process for digitally simulating acutance of analog film, in accordance with some embodiments. The method may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

With reference to FIG. 6, method 600 illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in method 600 may be performed in an order different than presented, and that not all of the blocks in the method may be performed. Some of the operations depicted may be performed in parallel or in a different sequence that does not materially affect the operation or result of method 600.

When film is processed in a “developer” chemical bath, the contrast within the image increases due to a spatial process, where the brightness of a particular color is changed based on the colors which surround it. This results in an aesthetically pleasing contrast increase that is unique to analog film and gives it visual dimension by enhancing brightness differences between image features. This visual property of the development process may be referred to as acutance. Due to the chemical reactions between the developer chemicals and the chemistry of the film, brightly exposed areas of an analog film image consume developer chemicals faster than darker image areas. This deprives dark areas of the developer chemicals which further lightens already bright areas and further darkens dark areas. The influence of the surrounding colors on one another is inversely proportionate to their distance from one another. Bright areas directly adjacent to dark areas will more drastically deprive those adjacent dark areas of the developer chemicals than if the distance between the areas was increased.

To emulate this chemical-induced characteristic within a digital image filter, a standard digital image processing tool (e.g., a color lookup table or (LUT)) is insufficient because it may not recognize spatial characteristics such as the contrast of a given position with respect to surrounding areas. A spatially aware process such as method 600 may more accurately simulate this process as follows.

At block 602, processing logic may obtain a first image of a sequence of images. The sequence of images may form a motion picture. At block 604, processing logic may generate a blurred version of the first image. For example, processing logic may apply a blurring algorithm such as a Gaussian blur to the first image.

At block 606, processing logic determines a difference between the first image and the blurred version at block 606. For example, processing logic may subtract the blurred version from the first image to obtain the difference. Image subtraction, which may also be referred to as pixel subtraction, is a process where the digital numeric value of an entire image or a single pixel is subtracted from another image or a single pixel. This difference may represent the magnitude of contrast between the light and dark areas with respect to distance between them.

At block 608, in response to the difference between the blurred version and the first image being positive, processing logic screens the difference over the first image resulting in a screened first image. In an embodiment, in response to the difference between the blurred version and the first image being negative, processing logic may negate the difference, invert the first image, screen the negated difference over the inverted first image, and invert the screened inverted first image, resulting in the screened first image. The implementation of the screen image blending allows for a sharpening of the image without clipping, and in the case of this algorithm this effect is applied to both the dark and light areas, thereby visually approximating the logarithmic nature of the analog film developer chemical process and visual acutance. For clarity, screen layer blending may include inverting each of the two images to be blended, multiplying them together, and then inverting the result. In other embodiments, screening may include additional or alternative operations.

At block 610, processing logic blends the screened first image with the first image. The resulting modified first image may have a sharpness akin to analog film stock. This brightens bright areas and darkens dark areas in proportion with their surroundings. The negative screen blending process results in the same non-clipping blending that occurs within film because acutance cannot fully underexpose or overexpose an image area to pure black or pure white.

In an embodiment, the method 600 may produce an output sharpened image that is used as an input image to method 200 (e.g., the first image) or system 300 (e.g., image 302), to further scatter and apply grain to the sharpened image, as described. In an embodiment, method 600 and method 200 may be performed in parallel and then the resulting images from each method may be blended together. Other combinations or order of operations may be performed without departing from the scope of the present disclosure.

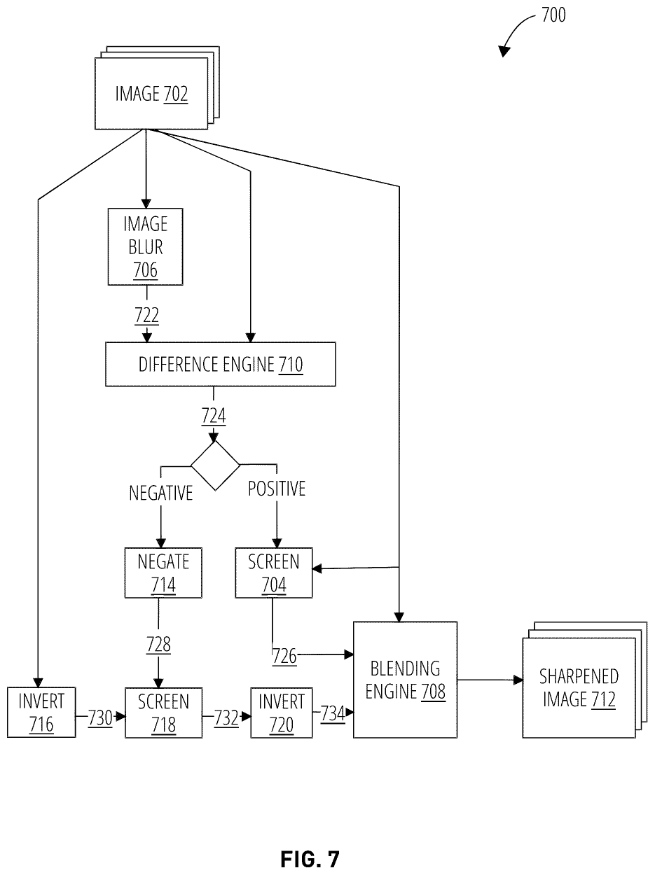

FIG. 7 illustrates an example system for digitally simulating acutance of analog film, in accordance with some embodiments. The system may perform processes described with respect to method 600. The system 700 may correspond to computing device 102. Each of the various engines and blocks described may be performed by processing logic of the system.

The system may perform processes that serve as a sharpening filter to produce an image contrast enhancement that does not clip shadows or highlights. The process may model the result of un-sharp-mask effects resulting from celluloid film developing chemicals, such as Rodinol, which is a significant factor in creating analog film's signature contrast.

One or more images 702 is obtained. The image 702 may be integral to a sequence of images that form a motion picture. In this and in other examples, image 702 may be extracted with a tool or application programming interface (API) of an imaging application. The image may correspond to an image of a frame of the motion picture. The image 702 may be a digital image.

At block 706 the system applies a blur algorithm to the image 702. In an embodiment, the blur algorithm is a Gaussian blur. The Gaussian blur may use a Gaussian function for calculating the transformation to apply to each pixel in the image 702, resulting in a blurred image 722.

Difference engine 710 may determine a difference 724 between the image 702 and the blurred image 722. In an embodiment, difference engine may subtract the blurred image 722 from the original image 702 to obtain the difference. The subtraction operation may operate pixel by pixel to determine which like positions of the two images are different and which are the same.

If the resulting difference 724 is positive, the system may proceed to block 704 and screen the difference over the original image 702. The resulting screened image 726 is blended back with the original image 702 at blending engine 708 to generate a sharpened image 712.

If the resulting difference 724 is negative, the system may proceed to block 714 and negate the difference 724. Further, the system may proceed to block 716 and invert image 702. An inverted image may also be referred to as a negative image in which light areas appear dark and dark areas appear light. The inverted image may also be color-reversed with red areas appearing cyan, greens appearing magenta, and blues appearing yellow, and vice versa. At block 718, the negated difference 728 may be screened with the inverted original 730 resulting in a screened inverted image 732. The system may then proceed to block 720 and invert the resulting screened inverted image 732, thus returning the resulting image 734 to normal (e.g., not inverted). The resulting image 734 may be blended with the original image 702 at blending engine 708 to generate the sharpened image 712. In such a manner, regardless of whether the difference 724 is positive or negative, the system 700 may produce a sharpened image 712 with acutance that emulates that of analog film. Blending engine 708 may overlay the sharpness filter image (e.g., image 726 or image 734) over image 702 with a less than 100% opacity to blend the two together, resulting in sharpened image 712.

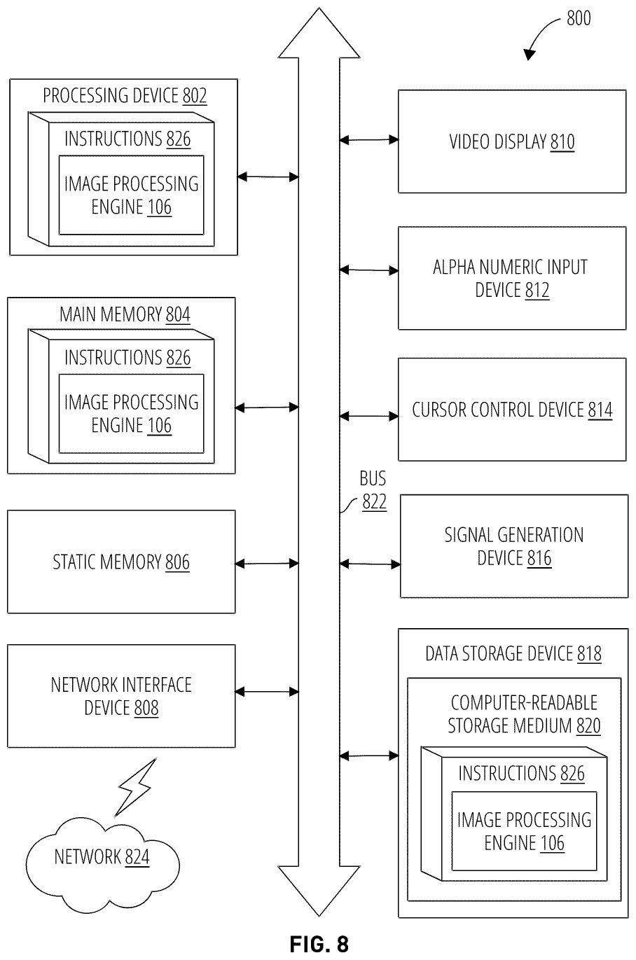

FIG. 8 is a block diagram of an example computing device 800 that may perform one or more of the operations described herein, in accordance with some embodiments. For example, the computing device 800 may perform one or more image processing operations on a digital image to emulate analog film characteristics.

Computing device 800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein. In one embodiment, such a computing device may also include the hardware and/or software within a mobile phone or tablet computer, or any such similar device. In one embodiment, such a computing device may also include a camera processing hardware and/or software within a digital still camera or digital motion picture camera, thereby modifying the live and/or recorded output of the camera to resemble analog film.

The example computing device 800 may include a processing device 802 (e.g., a general purpose processor, a PLD, etc.), a main memory 804 (e.g., synchronous dynamic random access memory (DRAM), read-only memory (ROM)), a static memory 806 (e.g., flash memory and a data storage device 818), which may communicate with each other via a bus 822.

Processing device 802 may be provided by one or more general-purpose processing devices such as a microprocessor, central processing unit, or the like. In an illustrative example, processing device 802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also comprise one or more special-purpose processing devices such as an application specific integrated circuit (ASIC), a field programmable gate array (FPGA), a digital signal processor (DSP), network processor, or the like. Processing device 802 may comprise multiple graphical processing units (GPU) s that are configured to perform operations in parallel. The processing device 802 may be configured to execute the operations described herein, in accordance with one or more aspects of the present disclosure, for performing the operations and steps discussed herein.

Computing device 800 may further include a network interface device 808 which may communicate with a network 824. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In one embodiment, video display unit 810, alphanumeric input device 812, and cursor control device 814 may be combined into a single component or device (e.g., an LCD touch screen).

Data storage device 818 may include a computer-readable storage medium 820 on which may be stored one or more sets of instructions 826 that may include instructions for a processing device (e.g., processing device 104), for carrying out the operations described herein, in accordance with one or more aspects of the present disclosure. Instructions 826 may also reside, completely or at least partially, within main memory 804 and/or within processing device 802 during execution thereof by computing device 800, main memory 804 and processing device 802 also constituting computer-readable media. The instructions 826 may further be transmitted or received over a network 824 via network interface device 808. The instructions 826 may contain instructions of an image processing engine 106 that, when executed, perform the operations and steps discussed herein.

While computer-readable storage medium 820 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “sending”, “storing”, “obtaining”, “receiving,” “routing,” “updating,” “providing,” “generating,” “determining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component may be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 110, sixth paragraph, for that unit/circuit/component. Additionally, “configured to” or “configurable to” may include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method performed by a processing device, comprising:
obtaining a first image of a sequence of images;
obtaining a grain image having a plurality of grains;
generating a resampled version of the first image including mapping pixels of the first image to different pixels in the second image based at least on a size of the plurality of grains in the grain film to generate the resampled version; and
applying the grain image and the resampled version to the first image, resulting in a modified first image with the plurality of grains.

2. The method of claim 1, wherein applying the resampled version to the first image comprises determining one or more edges in the first image and blending the resampled version with the first image with a reduced a visibility of the resampled version in the modified first image, at the one or more edges.

3. The method of claim 1, wherein applying the resampled version to the first image comprises and increasing or decreasing a visibility of the resampled version in different regions of the modified first image according to a brightness of the first image.

4. The method of claim 1, wherein applying the grain image to the first image comprises and increasing or decreasing a visibility of the grain image in different regions of the modified first image according to a brightness of the first image.

5. The method of claim 1, wherein generating the resampled version of the first image includes combining the grain image with a UV map and applying the resulting modified UV map to the first image to map pixels of the first image to different pixels in the second image according to at least the size and a geometry of the plurality of grains.

6. The method of claim 1, wherein the grain image is determined based on a user input that selects one of a plurality of settings, wherein each of the plurality of settings is associated with at least one of the size of the plurality of grains, a density of the plurality of grains, or a geometry of the plurality of grains.

7. The method of claim 1, wherein applying the grain image and the resampled version comprises compressing a first color range of the first image to a reduced color range in proportion to a desired granularity, blending the grain image and the resampled version to the first image with the reduced color range, and expanding the reduced color range of the resulting blended first image to the first color range.

8. The method of claim 1, further comprising repeating the method for a next image in the sequence of images using a second grain image.

9. The method of claim 1, further comprising:
generating a blurred version of the first image;
determining a difference between the first image and the blurred version;
in response to the difference between the blurred version and the first image being positive, screening the difference over the first image resulting in a screened first image, and
blending the screened first image with the first image, resulting in a sharpened image; and
combining the sharpened image with modified first image.

10. The method of claim 9, further comprising: in response to the difference between the blurred version and the first image being negative, negating the difference, inverting the first image, and screening the negated difference over the inverted first image, and inverting the screened inverted first image, resulting in the screened first image that is blended with the first image.

11. The method of claim 9, wherein determining the difference between the first image and the blurred version comprises subtracting the blurred version from the first image to obtain the difference.

12. A computing device, comprising: a processor coupled to non-transitory computer-readable memory having instructions that, when executed by the processor, cause the processor to perform operations comprising:
obtaining a first image of a sequence of images;
obtaining a grain image having a plurality of grains;
generating a resampled version of the first image including mapping pixels of the first image to different pixels in the second image based at least on a size of the plurality of grains in the grain film to generate the resampled version; and
applying the grain image and the resampled version to the first image, resulting in a modified first image with the plurality of grains.

13. The computing device of claim 12, wherein applying the resampled version to the first image comprises determining one or more edges in the first image and blending the resampled version with the first image with a reduced a visibility of the resampled version in the modified first image, at the one or more edges.

14. The computing device of claim 12, wherein applying the resampled version to the first image comprises and increasing or decreasing a visibility of the resampled version in different regions of the modified first image according to a brightness of the first image.

15. The computing device of claim 12, wherein applying the grain image to the first image comprises and increasing or decreasing a visibility of the grain image in different regions of the modified first image according to a brightness of the first image.

16. The computing device of claim 12, wherein generating the resampled version of the first image includes combining the grain image with a UV map and applying the resulting modified UV map to the first image to map pixels of the first image to different pixels in the second image according to at least the size and a geometry of the plurality of grains.

17. A non-transitory computer readable medium storing instructions that, when executed by a processor, causes the processor to perform operations comprising:
obtaining a first image of a sequence of images;
obtaining a grain image having a plurality of grains;
generating a resampled version of the first image including mapping pixels of the first image to different pixels in the second image based at least on a size of the plurality of grains in the grain film to generate the resampled version; and
applying the grain image and the resampled version to the first image, resulting in a modified first image with the plurality of grains.

18. The non-transitory computer readable medium of claim 17, wherein applying the resampled version to the first image comprises determining one or more edges in the first image and blending the resampled version with the first image with a reduced a visibility of the resampled version in the modified first image, at the one or more edges.

19. The non-transitory computer readable medium of claim 17, wherein applying the resampled version to the first image comprises and increasing or decreasing a visibility of the resampled version in different regions of the modified first image according to a brightness of the first image.

20. The non-transitory computer readable medium of claim 17, wherein applying the grain image to the first image comprises and increasing or decreasing a visibility of the grain image in different regions of the modified first image according to a brightness of the first image.
